(19) United States
(12) Patent Application Publication
(10) Pub. No.: US 2021/0287316 A1
(43) Pub. Date: Sep. 16, 2021

(54) METHODS AND SYSTEMS TO FACILITATE THE INTERACTION OF STUDENT PILOTS WITH CERTIFIED FLIGHT INSTRUCTORS, AND AIRCRAFT OWNERS

(71) Applicant: Joseph Trimmer, St Chalmette, LA (US)

(72) Inventor: Joseph Trimmer, St Chalmette, LA (US)

(21) Appl. No.: 17/084,351

(22) Filed: Oct. 29, 2020

Related U.S. Application Data
(60) Provisional application No. 62/927,891, filed on Oct. 30, 2019.

(51) Int. Cl. G06Q 50/20; G06Q 10/10; G06F 16/245

(52) U.S. Cl. CPC G06Q 50/205; G06Q 30/018; G06F 16/245; G06Q 10/10

(57) ABSTRACT

Methods and systems are provided to facilitate the interaction of student pilots with certified flight instructors and aircraft owners.

### CROSS-REFERENCE TO RELATED APPLICATION

The present application claims priority to provisional patent application Ser. No. 62/927,891 filed Oct. 30, 2019 and entitled “Method and Systems to Facilitate the Interaction of Student Pilots With Certified Flight Instructors, And Aircraft Owners.” Said application is incorporated herein by reference in its entirety.

### FIELD OF THE INVENTION

The present invention relates generally to data processing. More specifically, the present invention is methods and systems to facilitate the interaction of student pilots with certified flight instructors and aircraft owners.

### BACKGROUND OF THE INVENTION

Existing techniques for facilitating the interaction of student pilots with certified flight instructors and aircraft owners are deficient with regard to several aspects. For instance, current technologies do not address market inefficiency in the aviation industry. Further, the current technologies do not assist the student pilots in finding the certified flight instructors. Furthermore, the current technologies do not ease pilot shortage. Further, the current technologies do not assist the student pilots in verification of documents. Further, the current technologies do not facilitate verification of certifications associated with the student pilots, certified flight instructors, and aircraft owners that may be required to fly.

Therefore, there is a need for improved methods and systems to facilitate 25 interaction of student pilots with certified flight instructors, and aircraft owners that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a flowchart of a method to facilitate the interaction of student pilots with certified flight instructors, and aircraft owners is disclosed. Further, the method may include a step of receiving, using a communication device, at least one request associated with at least one student pilot from at least one student pilot device. Further, the method may include a step of analyzing, using a processing device, the at least one request to generate at least one query associated with at least one certified flight instructor. Further, the method may include a step of transmitting, using the communication device, the at least one query to at least one certified flight instructor device associated with the at least one certified flight instructor. Further, the method may include a step of receiving, using the communication device, a confirmation associated with the at least one query from the at least one certified flight instructor device. Further, the method may include a step of transmitting, using the communication device, an aircraft request to at least one aircraft owner device. Further, the method may include a step of receiving, using the communication device, an aircraft confirmation associated with the aircraft request from at least one aircraft owner device. Further, the method may include a step of transmitting, using the communication device, the aircraft confirmation to the at least one student pilot device and the at least one certified flight instructor device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system to facilitate the interaction of student pilots with certified flight instructors, and aircraft owners, in accordance with some embodiments.

FIG. 3 shows a flowchart of a method to facilitate the interaction of student pilots with certified flight instructors, and aircraft owners, in accordance with some embodiments.

FIG. 4 is a schematic of a system to illustrate the transmission of data among a plurality of stakeholders associated with the Part 61 software platform, in accordance with some embodiments

FIG. 5 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure contains headers. It should be understood that these headers are used as references and are not to be construed as limiting upon the subjected matter disclosed under the header. The present disclosure includes many aspects and features. Moreover, while many aspects and features relate to, and are described in the context of methods and systems to 25 facilitate interaction of student pilots with certified flight instructors, and aircraft owners, embodiments of the present disclosure are not limited to use only in this context.

Overview:

The present disclosure may describe methods and systems to facilitate the interaction of student pilots with certified flight instructors and aircraft owners. Further, the system may include a software platform Part 61. Further, the present disclosure relates to Federal Aviation Administration (FAA) Part 61 regulations. Further, the software platform Part 61 may be published on all distribution channels such as Apple™ App Store, Google™ Play, and others. Further, the software platform Part 61 will address a current market inefficiency in the aviation industry. Airplane owners mostly do not fly their planes regularly. Further, this results in airplanes tied down or hangared at airports most of the time. Further, the airplanes tied down or hangared at airports may pose a liability to the owner's finances. Further, owning airplanes may be expensive and many owners may love to ease that burden by renting the airplanes. Further, the Certified Flight Instructors (CFI) may have an option of joining a school that may force them to sign a non-compete agreement or find student pilots independently and train them. If the CFI does not own a plane that makes this path a challenge. Further, the student pilots may choose to train with a flight school. Further, the flight schools generally may prefer that the student pilot rents their planes for training. Further, if the student pilot buys his own plane training is much lower. The problem for students that may buy a plane to train on is finding qualified flight instructors to train them. Further, the software platform Part 61 fixes the market inefficiency by connecting student pilots with certified flight instructors and airplanes from owners that may want to monetize their planes. Further, the software platform Part 61 may profit from making these connections. Further, the software platform Part 61 may collect a portion of the training fee, a portion of the rent and will charge student pilots a membership fee and monthly dues. Further, the software platform Part 61 may also help ease the pilot shortage by making it much easier to On-ramp new student pilots by connecting them with airplanes and certified flight instructors. Further, the software platform Part 61 may verify that all members have current valid necessary certifications that may be needed to fly. Further, the software platform Part 61 may also make things easier for student pilots by connecting or interfacing with the appropriate FAA website and helping the new student pilot apply for a student certificate. Further, the software platform Part 61 may also help them schedule/book a doctor's appointment with an FAA-approved doctor to get the required medical screening. Further, all documents may be loaded into the software platform Part 61 for review and verification. Further, the software platform Part 61 may guide new student pilots through the process and check on them for progress through notifications until all legal documents required by the FAA have been submitted. This also applies to required documents for aircraft so the aircraft can join. Further, the software platform Part 61 may connect airplanes that may belong to private owners with people like student pilots, certified flight instructors and private pilots that may need an airplane to travel or learn new skills.

Further, the software platform Part 61 may be connected to the FAA websites. Further, the connection may make things easier for new student pilots when it's confusing to start. Further, the software platform Part 61 may talk to the FAA for the student pilots.

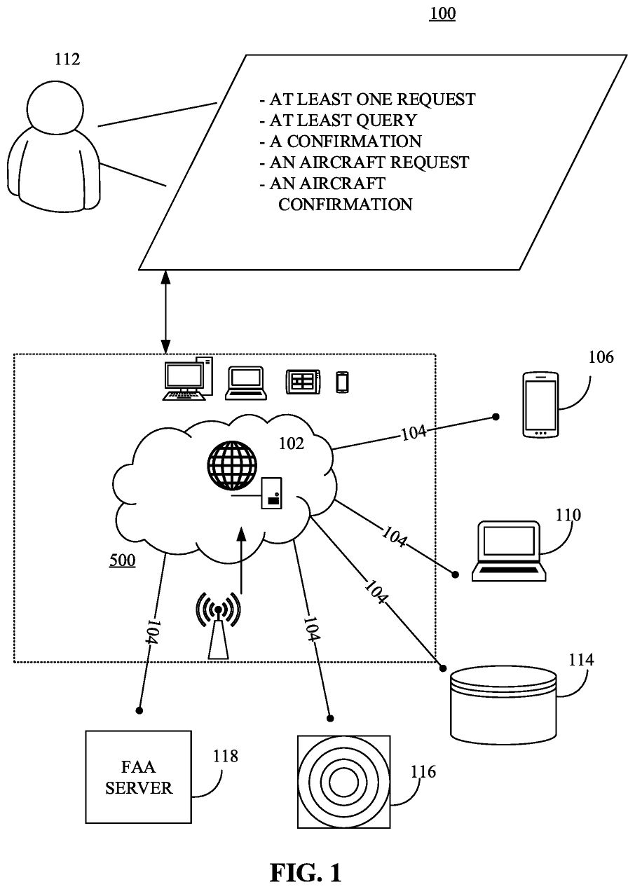

FIG. 1 is an illustration of an online platform 100 consistent with various embodiments of the present disclosure. By way of non-limiting example, the online platform 100 to facilitate interaction of student pilots with certified flight instructors, and aircraft owners may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, sensors 116, over a communication network 104, such as, but not limited to, the Internet. Further, users of the online platform 100 may include relevant parties such as, but not limited to, end users, student pilots, certified flight instructors, aircraft owners, and administrators. Accordingly, in some instances, electronic devices operated by the one or more relevant parties may be in communication with the online platform 100. Further, the sensor 116 may include a plurality of sensors. Further, the plurality of sensors may include aircraft sensors, physiological sensors, etc. Further, the aircraft sensors may be associated with sensors installed in the aircraft. Further, the physiological sensors may facilitate determination of physiological parameters associated with the student pilots, certified flight instructors, etc. Further, the physiological parameters may include heartbeat rate, blood pulse rate, respiration rate, etc.

A user 112, such as the one or more relevant parties, may access the online platform 100 through a web based software application or browser. The web based software application may be embodied as, for example, but not be limited to, a website, a web application, a desktop application, and a mobile application compatible with a computing device 500.

Further, the Federal Aviation Administration (FAA) server 118 may include data associated with the end users, but not limited to, student pilots, certified flight instructors and aircraft owners. Further, the data may include aircraft data and student physiological data. Further, the data may be transmitted to the online platform 100. Further, the aircraft data may include information associated with an aircraft that may include aircraft model, engine specification, etc. Further, the student physiological data may include information associated with the physiological parameters of the student while flying the aircraft.

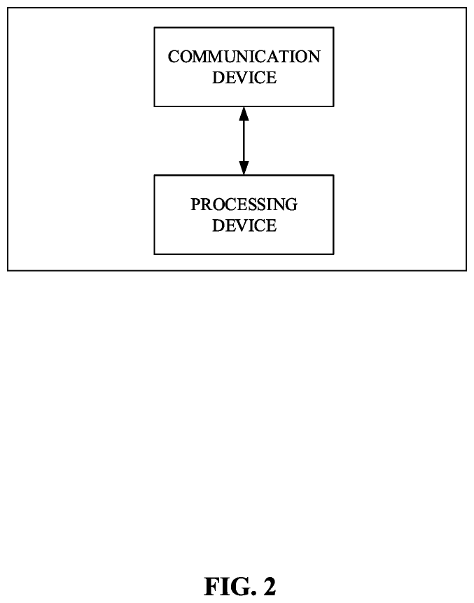

FIG. 2 is a block diagram of a system to facilitate interaction of student pilots with certified flight instructors, and aircraft owners, in accordance with some embodiments. Accordingly, the system may include a processing device and a communication device.

Further, the processing device may be configured for analyzing the at least one request to generate at least one query associated with at least one certified flight instructor. Further, the at least one request may be analyzed to determine parameters associated with the class session. Further, the parameters may include duration of training class, location of training class, location of training class, etc. further, the at least one query may be associated with the at least one certified flight instructor. Further, the certified flight instructor may include an individual, an institution, and an organization that may want to provide training class to the at least one student pilot.

Further, the communication device may be configured for receiving at least one request associated with at least one student pilot from at least one student pilot device. Further, the at least one request may facilitate selection of at least one second user. Further, the at least one second user may be an individual, an institution, and an organization that may be selected by the at least one student pilot. Further, the at least one student pilot may include an individual, an institution, and an organization that may want to schedule a training session. Further, the training session may refer to a training class associated with flying of an aircraft. Further, the at least one student pilot device may include a smartphone, a tablet, a laptop, a personal computer, and so on. Further, the communication device may be configured for transmitting the at least one query to at least one certified flight instructor device associated with the at least one certified flight instructor. Further, the at least one certified flight instructor device may include a smartphone, a tablet, a laptop, a personal computer and so on. Further, the communication device may be configured for receiving a confirmation associated with the at least one query from the at least one certified flight instructor device. Further, the confirmation may include a response from the at least one certified flight instructor. Further, the response may include a positive response and a negative response. Further, the positive response may refer to acceptance of the query. Further, the negative may refer to rejection of the query. Further, the communication device may be configured for transmitting an aircraft request to at least one aircraft owner device. Further, the aircraft request may be associated with the availability of an aircraft. Further, the aircraft request may include a plurality of details associated with availability of the aircraft. Further, the plurality of details may include model of aircraft, duration of the training class, location of training class, and so on. Further, the at least one aircraft owner device may be associated with at least one aircraft owner. Further, the aircraft owner may be an individual, an institution, and an organization that may own at least one aircraft. Further, the at least one aircraft owner device may include a smartphone, a tablet, a laptop, a personal computer, and so on. Further, the communication device may be configured for receiving an aircraft confirmation associated with the aircraft request from at least one aircraft owner device. Further, the aircraft confirmation may include a response and a plurality of aircraft details that may be provided by the at least one aircraft owner to the at least one student pilot. Further, the plurality of details may include model of aircraft, price of the training session, duration of the training class, location of training class, and so on. Further, the response may include a positive response and a negative response. Further, the positive response may refer to acceptance of the aircraft request. Further, the negative may refer to rejection of the aircraft query. Further, the communication device may be configured for transmitting the aircraft confirmation to the at least one student pilot device and the at least one certified flight instructor device.

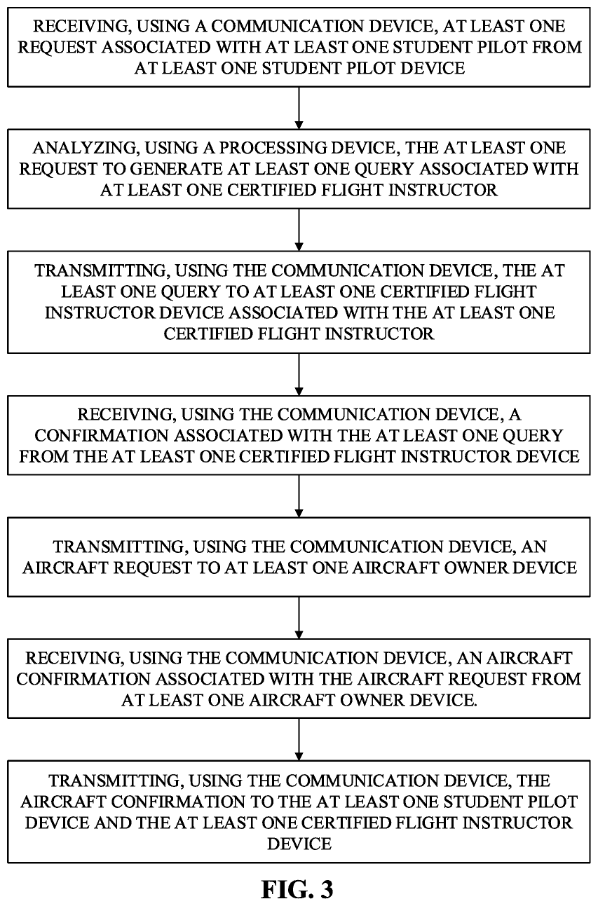

FIG. 3 is a flowchart of a method to facilitate interaction of student pilots with certified flight instructors and aircraft owners, in accordance with some embodiments. Accordingly, the method may include a step of receiving, using a communication device, at least one request associated with at least one student pilot from at least one student pilot device. Further, the at least one request may facilitate selection of at least one second user. Further, the at least one second user may be an individual, an institution, and an organization that may be selected by the at least one student pilot. Further, the at least one student pilot may include an individual, an institution, and an organization that may want to schedule a training session. Further, the training session may refer to a training class associated with flying of an aircraft. Further, the at least one student pilot device may include a smartphone, a tablet, a laptop, a personal computer, and so on.

Further, the method may include a step of analyzing, using a processing device, the at least one request to generate at least one query associated with at least one certified flight instructor. Further, the at least one request may be analyzed to determine parameters associated with the class session. Further, the parameters may include duration of training class, location of training class, location of training class, etc. further, the at least one query may be associated with the at least one certified flight instructor. Further, the certified flight instructor may include an individual, an institution, and an organization that may want to provide training class to the at least one student pilot.

Further, the method may include a step of transmitting, using the communication device, the at least one query to at least one certified flight instructor device associated with the at least one certified flight instructor. Further, the at least one certified flight instructor device may include a smartphone, a tablet, a laptop, a personal computer and so on.

Further, the method may include a step of receiving, using the communication device, a confirmation associated with the at least one query from the at least one certified flight instructor device. Further, the confirmation may include a response from the at least one certified flight instructor. Further, the response may include a positive response and a negative response. Further, the positive response may refer to the acceptance of the query. Further, the negative may refer to rejection of the query.

Further, the method may include a step of transmitting, using the communication device, an aircraft request to at least one aircraft owner device. Further, the aircraft request may be associated with the availability of an aircraft. Further, the aircraft request may include a plurality of details associated with availability of the aircraft. Further, the plurality of details may include model of aircraft, duration of the training class, location of training class, and so on. Further, the at least one aircraft owner device may be associated with at least one aircraft owner. Further, the aircraft owner may be an individual, an institution, and an organization that may own at least one aircraft. Further, the at least one aircraft owner device may include a smartphone, a tablet, a laptop, a personal computer, and so on.

Further, the method may include a step of receiving, using the communication device, an aircraft confirmation associated with the aircraft request from at least one aircraft owner device. Further, the aircraft confirmation may include a response and a plurality of aircraft details that may be provided by the at least one aircraft owner to the at least one student pilot. Further, the plurality of details may include model of aircraft, price of the training session, duration of the training class, location of training class, and so on. Further, the response may include a positive response and a negative response. Further, the positive response may refer to the acceptance of the aircraft request. Further, the negative may refer to the rejection of the aircraft query.

Further, the method may include a step of transmitting, using the communication device, the aircraft confirmation to the at least one student pilot device and the at least one certified flight instructor device.

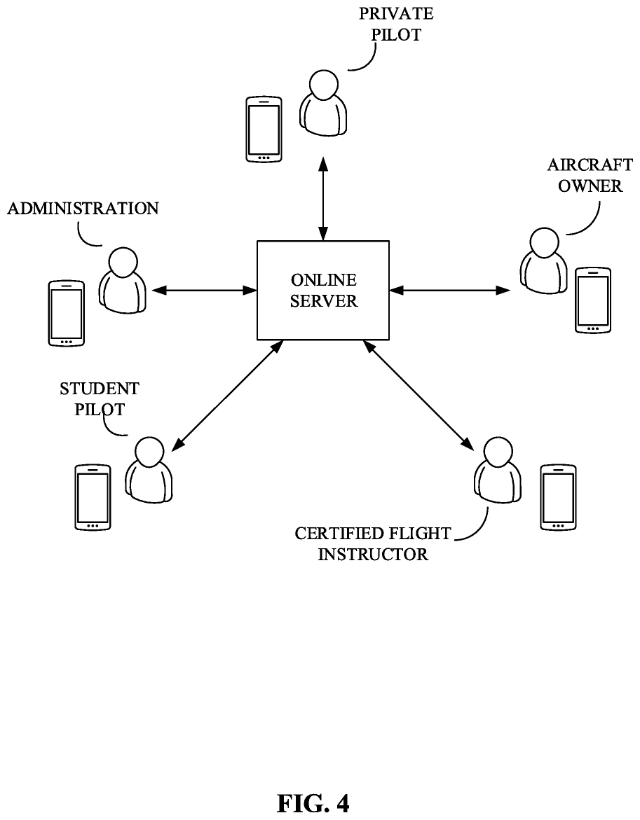

FIG. 4 is a schematic of a system to illustrate the transmission of data among a plurality of stakeholders associated with the Part 61 software platform, in accordance with some embodiments. Further, the system may include a plurality of stakeholders associated with the Part 61 software platform. Further, the Part 61 software platform may operate within the guardrails of Part 61 of Federal Aviation Regulations (FAR). Further, the plurality of stakeholders may include private pilots, aircraft owners, certified flight instructors, student pilots, administrators. Further, upon signing up for the Part 61 software platform by a stakeholder of the plurality of stakeholders, verification of the stakeholder may be facilitated by the Part 61 software platform. Further, the verification may be may done upon uploading of plurality of documents associated with the stakeholder. Further, the plurality of documents may be authorized by the Federal Aviation Administration (FAA). Further, the private pilots may view list of available aircrafts that may be submitted by the at least one aircraft owner for use on the part. Further, the private pilots may need to submit/upload a private pilot license, a medical 30 certificate, and so on for verification. Further, the verification may ensure the qualification of the private pilots for the aircraft that the private pilot may want to fly.

Further, the aircraft that may be available to rent on the app for the private pilots may match the qualification of the private pilots.

Further, the airplane owners may be able to make their aircraft available to private pilots and student pilots with a Certified Flight Instructor (CFI) or a student pilot that may be authorized to fly alone. Further, the aircraft owner may set the hourly rate. Further, the Part 61 software platform may display the aircraft as available. Further, aircraft maintenance and insurance may meet commercial requirements such as commercial insurance, 100 hr inspections, and appropriate oil changes. Further, the aircraft owners may submit POH, Airworthiness certificate, registration insurance, maintenance logbooks, and weight and balance document. Further, the Part 61 software platform may collect a percentage of the rental rate for making the connection.

Further, the certified flight instructors may be able to rent aircraft from airplane owners to train student pilots. Further, the certified flight instructors may need to submit all appropriate documentation that may verify the certified flight instructors as authorized by the FAA. Further, the certified flight instructors may choose/charge a training fee. Further, the Part 61 software platform may collect a small fee for making the connection.

Further, the Part 61 software platform may guide student pilots. Further, to sign up, the student pilot may submit a student pilot license, a temp student pilot license and a medical. Further, upon non availability of an endorsement document by a certified flight instructor and a medical certificate, the student pilots may not be able to fly solo. Further, the Part 61 software platform may help the student pilots to navigate to appropriate locations of the FAA website to get the temporary certificate and find the FAA doctor for the medical. Further, the Part 61 software platform may automate signup process and steps on the FAA website. Further, the Part 61 software platform may take the information the student pilot submits at the beginning and auto-populate as much as possible on the FAA website. Further, the video https://youtu.be/u2IXnkhBsbQ may show how to register for a student pilot certificate. Further, the website is https://iacra.faa.gov. further, the student pilots may begin to fly with the certified flight instructors, upon receiving of the temp student pilot certificate. Further, the student pilots may pay for aircraft rental and certified flight instructor fees. Further, the Part 61 software platform may collect a fee from the training and from the rental.

Further, the administrator may manage all the users, booking and payments on the Part 61 software platform. Further, the administrator may review all submitted documentation and approve or deny the users.

Further, the private pilots, the student pilots, and the certified flight instructors may require to fly with a company certified flight instructor to get a go/no go from an experienced certified flight instructor before flying for the first time on the Part 61 software platform for extra safety.

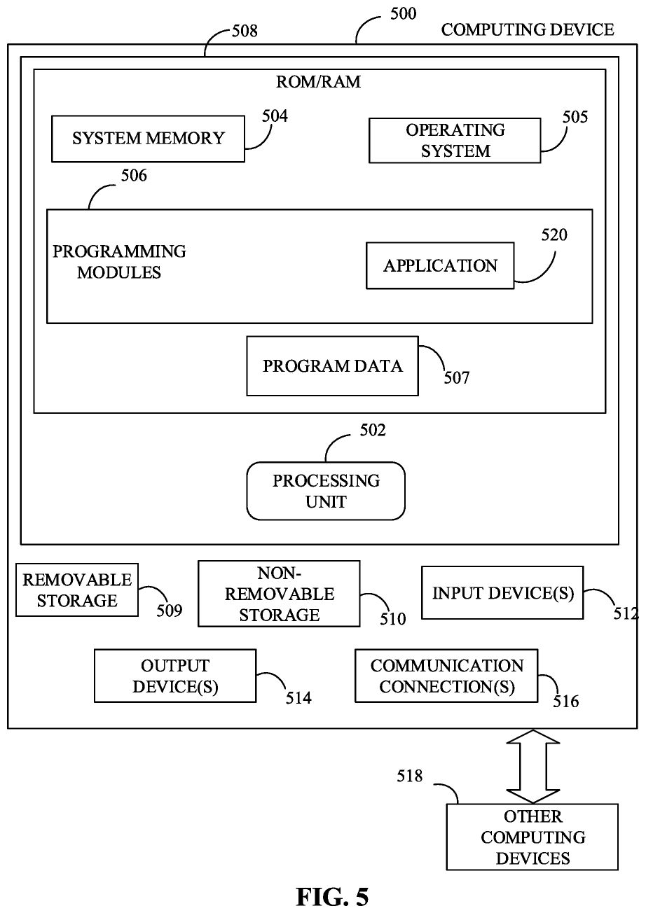

With reference to FIG. 5, a system consistent with an embodiment of the disclosure may include a computing device or cloud service, such as computing device 500. In a basic configuration, computing device 500 may include at least one processing unit 502 and a system memory 504. Depending on the configuration and type of computing device, system memory 504 may comprise, but is not limited to, volatile (e.g. random-access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500's operation. In one embodiment, programming modules 506 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer-readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, a location sensor, a camera, a biometric sensor, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., application 520 such as a media player) may perform processes including, for example, one or more stages of methods, algorithms, systems, applications, servers, databases as described above. The aforementioned process is an example, and processing unit 502 may perform other processes. Other programming modules that may be used in accordance with embodiments of the present disclosure may include machine learning application.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I claim:

1. A method for facilitating the interaction of student pilots with certified flight instructors and aircraft owners, said method comprising the steps:
receiving, using a communications device, at least one request associated with at least one student pilot from at least one student pilot device;
analyzing, using a processing device, said at least one request to generate at least one query associated with at least one certified flight instructor;
transmitting, using said communications device, said at least one query to at least one certified flight instructor device associated with the at least one certified flight instructor;
receiving, using said communications device, a confirmation associated with said at least one query from the at least one certified flight instructor device;
transmitting, using said communication device, an aircraft request to at least one aircraft owner device;
receiving, using said communication device, an aircraft confirmation associated with said aircraft request from at least one aircraft owner device; and
transmitting, using said communications device, said aircraft confirmation to the at least one said student pilot device and the at least one said certified flight instructor device.
